(19) United States
(12) Patent Application Publication
(10) Pub. No.: US 2012/0001849 A1
(43) Pub. Date: Jan. 5, 2012

(54) MULTI-FUNCTIONAL MOUSE

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/878,214

(22) Filed: Sep. 9, 2010

(30) Foreign Application Priority Data
Jun. 30, 2010 (CN) 201020242666.5

(51) Int. Cl. G09G 5/08

(52) U.S. Cl. 345/163

(57) ABSTRACT

A multi-functional mouse transmits to an electronic device through radio signals. The multi-functional mouse comprises a power source supplies power for the multi-functional mouse, a navigation module controlling the coordinates of a cursor on a screen of the electronic device, an audio output module converting electronic audio signals into sounds, an audio input module receiving and converting sounds into audio signals and transmits the audio signals to electronic device, and a wireless transceiver module. The mouse electronically communicates with the electronic device.

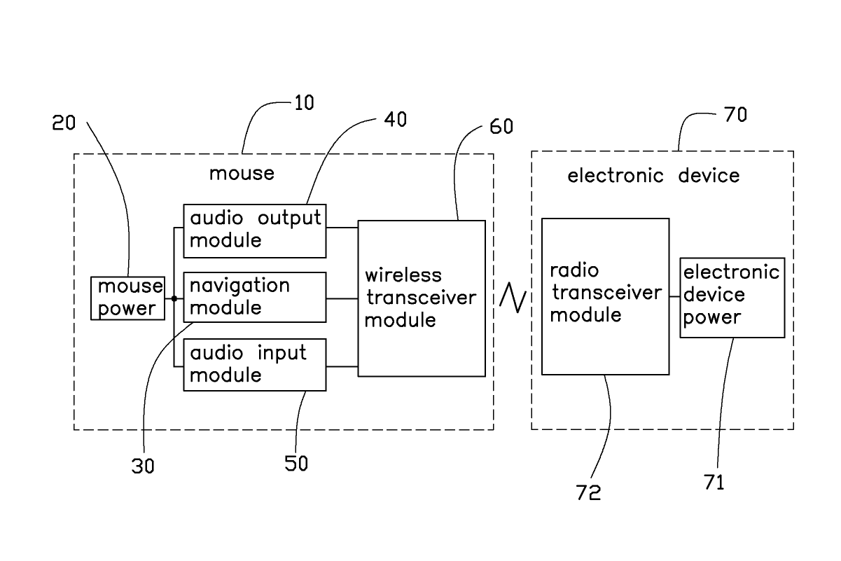

### CROSS-REFERENCE TO RELATED APPLICATIONS

This application is related to co-pending U.S. Patent Applications (Attorney Docket No. US33682, AND US33683), all entitled “MULTI-FUNCTIONAL MOUSE”, by Wu et al. These applications have the same assignee as the present application and have been concurrently filed herewith. The above-identified applications are incorporated herein by reference.

### BACKGROUND

1. Technical Field

This disclosure relates to multi-functional mice.

2. Description of Related Art

Modern desktop computers provide users with user-input mechanisms that are well suited for the applications that run on these computers. For example, the desktop computers often use an external peripheral devices, such as a mouse, that allows the user to conveniently navigate through menus of an application, as well as allowing navigation between applications and selection of various choices like a “click and drag” option. However, most typical mice have only a navigation function.

Therefore, there is room for improvement in the art.

### BRIEF DESCRIPTION OF THE DRAWINGS

Many aspects of the embodiments can be better understood with reference to the following FIGURE. The components in the drawings are not necessarily drawn to scale, the emphasis instead being placed upon clearly illustrating the principles of the exemplary multi-functional mouse for electronic device. Moreover, in the drawings like reference numerals designate corresponding parts throughout the several views. Wherever possible, the same reference numbers are used throughout the drawings to refer to the same or like elements of an embodiment.

The FIGURE is a block diagram of an exemplary embodiment of a multi-functional mouse.

### DETAILED DESCRIPTION

An exemplary multi-functional mouse 10 is schematically illustrated in the FIGURE. The mouse 10 may communicate with an electronic device 70 (e.g., computer) by wireless communication technology. The mouse 10 includes a power source 20, a navigation module 30, an audio output module 40, an audio input module 50, and a wireless transceiver module 60. The power source 20 supplies power for the mouse 10. The navigation module 30, the audio input module 50 and the audio output module 40 electronically connect to the wireless transceiver module 60 to wirelessly communicate with the electronic device 70. The electronic device 70 includes an electronic device power source 71 and a radio transceiver module 72. The electronic device power source 71 supplies power for the radio transceiver module 72.

The power source 20, respectively and electrically, connects to and supplies power for the navigation module 30, the audio output module 40 and the audio input module 50. The power source 20 can be a rechargeable battery or a detachable battery pack so that the power source 20 can be recharged or replaced by a new power supply when the power source 20 is exhausted.

Though in other embodiments of the invention, the mouse may be hard wired to the electronic device, in the exemplary embodiment, the wireless transceiver module 60, respectively and electronically, connects to the navigation module 30, the audio output module 40 and the audio input module 50. The navigation module 30 controls the coordinates of a cursor on a screen of the electronic device 70 as the mouse 10 moves around on a mouse pad. The audio output module 40 converts electronic audio signals received from the wireless transceiver module 60 into sounds, so that the mouse 20 can playing audio files received from the electronic device 70. The audio input module 50 receives and converts sounds into audio signals and transmits the audio signals to the electronic device 70 through a wireless communication therebetween, so that the electronic device 70 can receive sounds from the mouse 20. The wireless transceiver module 60 may be BLUETOOTH RF technology or 2.4 Ghz radio frequency technology for implementing wireless communication.

To use the navigation module 30, the power source 20 supplies power to the navigation module 30. The navigation module 30 generates and sends indicating signals to the wireless transceiver module 60. Then the wireless transceiver module 60 transmits the indicating signals from the navigation module 30 to the radio transceiver module 72 to control the coordinates of the cursor on the screen.

To use the audio input module 50, the power source 20 supplies power to the audio input module 50. The audio input module 50 receives and converts sounds into audio signals and transmits the audio signals to electronic device 70 through a wireless communication therebetween, so that the electronic device 70 can receive sounds from the mouse 20.

To use the audio output module 40, the power source 20 supplies power to the audio output module 40. The audio output module 40 generates a signal to the wireless transceiver module 60, and then the wireless transceiver module 60 transmits the signal from the audio output module 40 to the radio transceiver module 72, to output audio signals from the electronic device 70.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A multi-functional mouse electronically communicating with an electronic device, the multi-functional mouse comprising:
a power source supplies power for the multi-functional mouse;
a navigation module controlling the coordinates of a cursor on a screen of the electronic device;
an audio output module converting electronic audio signals into sounds;
an audio input module receiving and converting sounds into audio signals and transmits the audio signals to electronic device; and
the mouse electronically communicating with the electronic device.

2. The multi-functional mouse as claimed in claim 1, wherein the mouse electronically communicates to the electronic device using a wireless transceiver module in the mouse communicating with the electronic device via wireless communication technology; the wireless transceiver module, respectively and electrically, connecting to the navigation module, the audio input module and the audio output module.

3. The multi-functional mouse as claimed in claim 2, wherein the power source, respectively and electrically, connects to the navigation module, the audio output module and the audio input module.

4. The multi-functional mouse as claimed in claim 2, wherein the power source is rechargeable.

5. The multi-functional mouse as claimed in claim 2, wherein the wireless transceiver module is Bluetooth or 2.4 G radio frequency.
